(19) United States
(12) Patent Application Publication
(10) Pub. No.: US 2020/0357302 A1
(43) Pub. Date: Nov. 12, 2020

(54) METHOD FOR DIGITAL LEARNING AND NON-TRANSITORY MACHINE-READABLE DATA STORAGE MEDIUM

(71) Applicant: TUTOR GROUP LIMITED, Wan Chai (HK)

(72) Inventor: Cheng-Ta YANG, Taipei (TW)

(21) Appl. No.: 16/869,687

(22) Filed: May 8, 2020

(30) Foreign Application Priority Data
May 9, 2019 (CN) 201910385296.6

(51) Int. Cl. G09B 19/06; G09B 5/06; G06K 9/44

(52) U.S. Cl. CPC G09B 19/06; G06K 9/44; G09B 5/065

(57) ABSTRACT

A method for remote digital learning includes: providing plural teaching videos that each correspond to one of plural teachers and one of plural teaching materials; selecting a designated teacher from among the plural teachers based on student tags related to a user and teacher tags related to the plural teachers; selecting a designated teaching material from among the plural teaching materials based on the student tags and teaching material tags related to the plural teaching materials; from among the plural teaching videos, selecting a designated video that corresponds to both of the designated teacher and the designated teaching material; and providing the designated video to the user.

### CROSS-REFERENCE TO RELATED APPLICATION

This application claims priority of Chinese Invention Patent Application No. 201910385256.6, filed on May 9, 2019.

### FIELD

The disclosure relates to digital learning, and more particularly to a method for digital learning, and non-transitory machine-readable data storage medium storing instructions for the same.

### BACKGROUND

Digital learning (including online learning) allows a student to attend a class via the Internet at any time or any place he/she desires. A conventional digital learning system, such as Duolingo, utilises a digital online platform to provide a student with teaching materials in text form to teach the student a certain language. However, it is difficult for a student to learn proper pronunciation when learning a language through such plat form-type learning system because of the lack of human faces to demonstrate the mouth shapes and movements.

### SUMMARY

Therefore, an object of the disclosure is to provide a method for digital learning that can alleviate at least one of the drawbacks of the prior art, and a non-transitory machine-readable data storage medium storing program instructions for configuring a computer to perform the method.

According to one aspect of the disclosure, the method for digital learning includes the following steps of: providing plural teaching videos, each of which corresponds to one of plural teachers and to one of plural teaching materials; selecting a designated teacher from among the plural teachers based on a set of student tags and plural sets of teacher tags, the set of student tags being related to a user, each of the plural sets of teacher tags being related to a respective one of the plural teachers; selecting a designated teaching material from among the plural teaching materials based on the set of student tags of the user and plural sets of teaching material tags, each of the plural sets of teaching material tags being related to a respective one of the plural teaching materials; selecting, from among the plural teaching videos, a designated video that corresponds to both of the designated teacher and the designated teaching material; and providing the designated video to the user.

### BRIEF DESCRIPTION OF THE DRAWINGS

Other features and advantages of the disclosure will become apparent in the following detailed description of the embodiment(s) with reference to the accompanying drawings, of which:

FIG. 1 exemplarily illustrates a method for digital learning according to an embodiment of the disclosure;

FIG. 2 exemplarily illustrates sub-steps of Step 100 of FIG. 1 according to an embodiment of the disclosure;

FIG. 3 exemplarily illustrates sub-steps of Sub-step 150 of FIG. 2 according to an embodiment of the disclosure;

FIG. 4 exemplarily illustrates sub-steps of Step 200 of FIG. 1 according to an embodiment of the disclosure;

FIG. 5 exemplarily illustrates sub-steps of Sub-step 230 of FIG. 4 according to an embodiment of the disclosure;

FIG. 6 exemplarily illustrates an implementation of Step 300 of FIG. 1 according to an embodiment of the disclosure;

FIG. 7 exemplarily illustrates another implementation of Step 300 of FIG. 1 according to an embodiment of the disclosure; and

FIG. 8 exemplarily illustrates a computer system according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

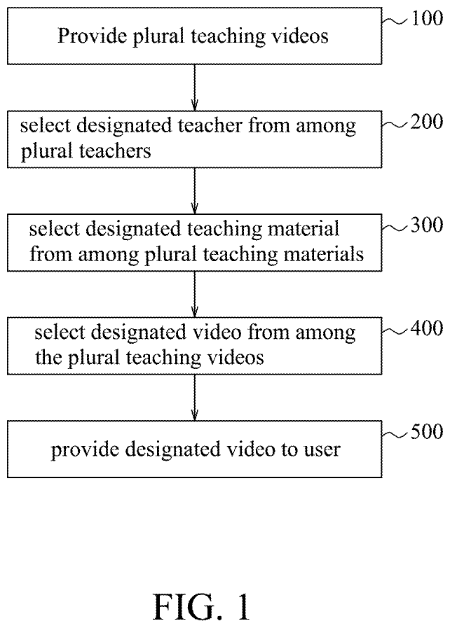

FIG. 1 exemplarily illustrates a method for digital learning according to an embodiment of the disclosure. According to some embodiments, the method maybe performed by, for example, at least one computing system (e.g., at least one server computer) each including memory for storing program instructions and at least one processor for executing said program instructions.

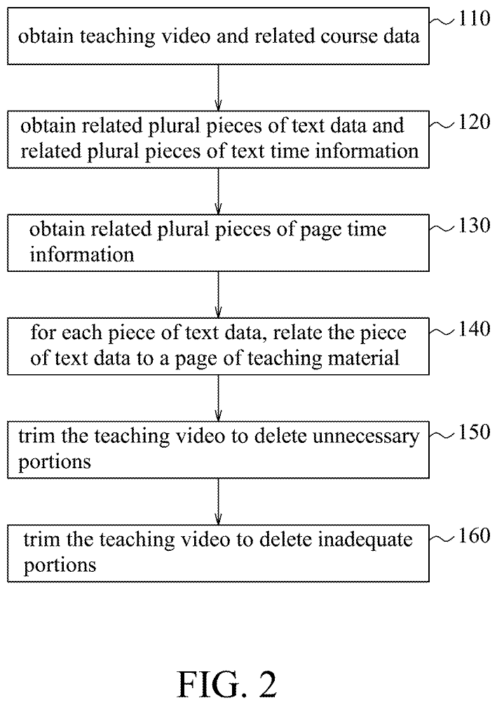

Referring to FIG. 1, the illustrated method includes Steps 100-500. Step 100 is to provide plural teaching videos, each of which corresponds to one. of plural teachers and to one of plural teaching materials. A teaching video corresponding to a teacher and a teaching material means that the teacher acts and gives a lesson by using the teaching material in the teaching video. Each of the plural teachers is related to a different set of teacher tags, and each of the plural teaching materials is related to a different set of teaching material tags. According to some embodiments, the teaching materials may be textbooks. Each set of teacher tags includes a set of teacher characteristic tags and a set of teacher subject tags; each of the plural sets of teaching material tags (i.e., each set of teaching material tags) includes a set of teaching subject tags. According to some embodiments, the set of teacher characteristic tags of each set of teacher tags may include but is not limited to, for example, a tag indicating the sex of the teacher, a tag indicating an accent type of the teacher, and/or a tag indicating an age of the teacher. According to some embodiments, the set of teacher subject tags of each set of teacher tags and the set of teaching subject tags of each set of teaching material tags may each include but not limited to, for example, at least one tag indicating at least one subject such as American English, British English, business English, teenager English, TOFEL, TOEIC, etc. Each of the at least one subject indicated by a tag in a set of teacher subject tags is a subject which the teacher related to the set of teacher subject tags can teach, and each of the at least one subject indicated by a tag in a set of teaching subject tags is a subject of the teaching material related to the set of teaching subject tags. Details of Step 100 are illustrated in FIG. 2 and will be described later.

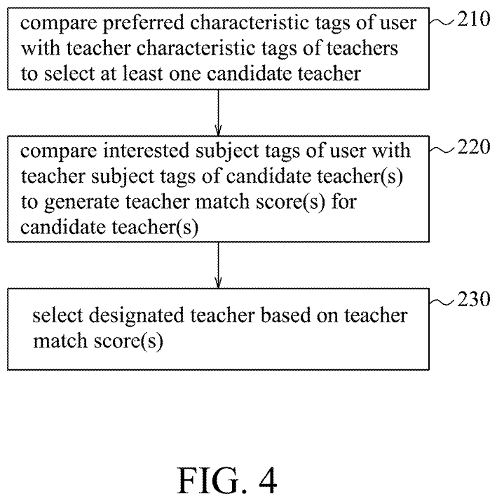

Step 200 is to select a designated teacher from among the plural teachers based on the sets of teacher tags related thereto, and on a set of student tags related to a user, who is a student ready to use a learning service provided by said method to learn something. The set of student tags may be provided by the user when or after he/she registered an account to use the learning service. The set of student tags includes a set of preferred characteristic tags and a set of interested subject tags. According to some embodiments, the set of preferred characteristic tags may include but is not limited to, for example, a tag indicating a preferred sex of the teacher, a tag indicating a preferred accent type, and/or. a tag indicating a preferred range of age of a teacher. According to some embodiments, the set of interested subject tags may include but is not limited to, for example, at least one tag indicating at least one subject such as American English, British English, business English, teenager English, 7CFEL, TOEIC, etc. Each of the at least one subject indicated by a tag in the set of interested subject tags is a subject which the user is interested in learning. Details of Step 200 are illustrated in FIG. 4 and will be described later.

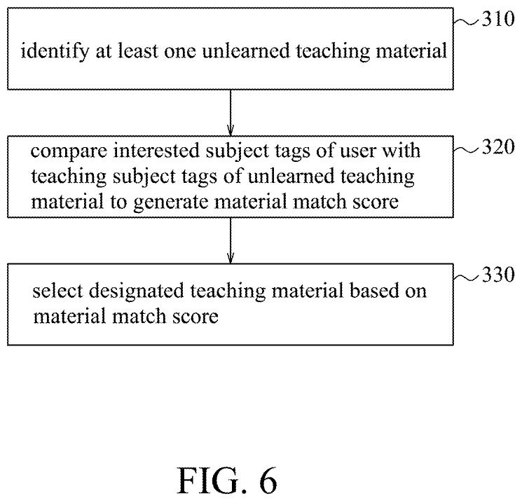

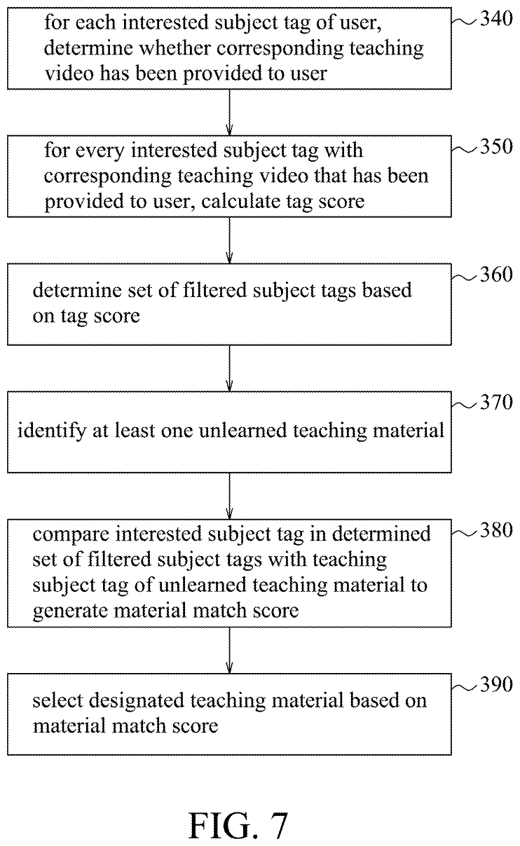

Step 300 is to select a designated teaching material from among the plural teaching materials based on the sets of teaching material tags related thereto, and on the set of student tags. It should be noted that it is not necessary for Step 300 to follow Step 200. That is, Step 300 may also be performed before Step 200, or simultaneously with Step 200. Details of Step 300 are illustrated in FIGS. 6 and 7 and will be described later.

Step 400 is to select, from among the plural teaching videos, a designated video that best fits the user's needs. Specifically, Step 400 is to select one of the plural teaching videos that, corresponds to both of the designated teacher selected in Step 200 and the designated teaching material selected in Step 300 to serve as the designated video.

Last, Step 500 is to provide (e.g., using push technology) the designated video selected in Step 400 to the user, such that the user may attend a course provided by the designated video by, for example, watching the designated video on an electronic device (e.g., a personal computer (PC), a notebook, a tablet, or a smart phone) the user possesses. According to some embodiments, after the user has finished the course provided by the designated video, a grading score with respect to the course will be given by the user.

FIG. 2 exemplarily illustrates sub-steps of Step 100 according to an embodiment of the disclosure, Referring to FIG. 2, Step 100 may include Sub-steps 110-160 that are performed for each of the plural teaching videos.

Sub-step 110 is to obtain the teaching video (i.e., one of the plural teaching videos mentioned above) and a piece of course data related to the teaching video. According to some embodiments, the teaching video may be prerecorded, and the piece of course data may be prepared along with the teaching video. The piece of course data includes teacher information of the teacher that corresponds to the teaching video, and teaching material information of the teaching material that corresponds to the teaching video. That is, the teaching video may be mapped to the teacher and the teaching material based on the piece of coarse data. According to some embodiments, mapping relationships between the teaching video and the teacher and between the teaching video and the teaching material may be stored in, for example, a. lookup table for later use.

Each of the teaching videos includes plural speech segments. In some, embodiments, a speech segment of a teaching video is a portion of speech data of the teaching video, and corresponds to a consecutive passage of words a teacher utters in the teaching video. Sub-step 120 is to obtain plural pieces of text data corresponding respectively to the plural speech segments included in the teaching video, and plural pieces of text time information corresponding respectively to the plural pieces of text data. Each piece of text data represents the text of the consecutive passage of words that corresponds to the respective speech segment, which corresponds to the piece of text data. Each of the plural pieces of text time information Indicates a start time point and a finish time point of the corresponding piece of text data that correspond respectively to a start time point and a finish time point of the speech segment to which said piece of text data corresponds. According to some embodiments, the plural pieces of text data thus obtained may be stored in chronological order based on the plural pieces of text time information.

According to some embodiments, the text data and the text time information may be obtained by applying speech recognition and text segmentation with natural language processing (NLP) on the teaching videos. Existing techniques, such as bidirectional I,STM and conditional random fields (Bi-LSTM-CRF) or deep learning, may also be utilised for language recognition According to some embodiments, voice activity detection (VAD) (or speech end-point detection) may be utilized to recognize each speech segment in a teaching video.

Sub-step 130 is to obtain plural pieces of page time information based on the teaching material information in the piece of course data related to the teaching video The plural pieces of page time information correspond respectively to plural video segments of the teaching video. The plural video segments correspond respectively to plural pages of the teaching material that corresponds to the teaching video. Each piece of page time information indicates a start time point and a finish time point of the respective video segment, which corresponds to the piece of page time information In an embodiment, the plural pieces of page time information are included in the teaching material information. It should be noted that it is not necessary for Sub-step 130 to follow Sub-step 120. That is, Sub-step 130 may also be performed before Sub-step 120, or simultaneously with Sub-step 120.

Sub-step 140 is to, for each of the plural pieces of text data, relate the piece of text data to one of the plural pages of the teaching material based on the piece of text time information corresponding to the piece of text data and on the plural pieces of page time information. That is, each piece of text data is mapped to one of the plural pages of the teaching material.

According to some embodiments, mapping relationships between the pieces of text data and the pages of the teaching material may also be stored in, for example, a lookup table for later use.

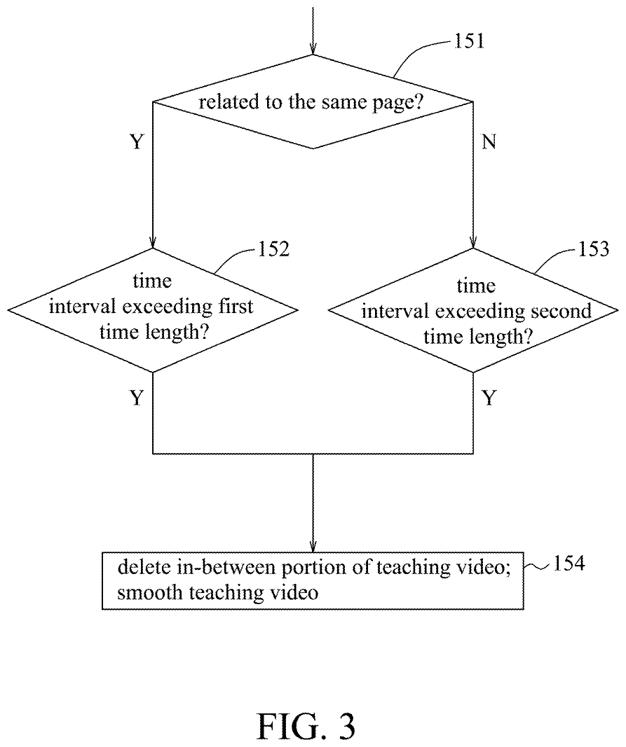

Sub-step 150 is to trim the teaching video to delete unnecessary portions thereof based on the text data. Referring to FIG. 3, Sub-step 150 includes Sub-steps 151-155 that are to be performed for each of the plural pieces of text data.

Sub-step 151 is to determine whether the piece of text data (referred to as “the current piece of text data” hereinafter) is related to a page that is also related to another piece of text data, with the another piece of text data being immediately before the current piece of text data in the chronological order (referred to as “the previous piece of text data” hereinafter). If so, the procedure goes to Sub-step 152; otherwise, the procedure goes to Sub-step 153.

Sub-step 152 is to determine whether a time interval between the finish time point of the previous piece of text data and the start time point of the current piece of text data exceeds a first time length. If so, the procedure goes to Sub-step 154; otherwise, the procedure for the piece of text data ends. According to some embodiments, the first time length may be, for example, 5-10 seconds, but the disclosure is not limited thereto.

Sub-step 153 is to determine whether the time interval between the finish time point of the previous piece of text data and the start time point of the current piece of text data exceeds a second time length. If so, the procedure goes to Sub-step 154; otherwise, the procedure for the piece of text data ends. According to some embodiments, the second time length may be greater than the first time length, and may be, for example, 15-30 seconds, but the disclosure is not limited thereto.

Sub-step 154 is to delete a portion of the teaching video between the speech segment that corresponds to the current piece or text data and the speech segment that corresponds to the previous piece of text data. According to some embodiments, Sub-step 154 may further smooth the teaching video. In an embodiment, smoothing of the teaching video is accomplished by obtaining a substitutional clip that, has a duration of, for example, 1 second, and inserting the substitutional clip into the teaching video to replace the portion of the teaching video thus deleted. For example, the substitutional clip may be obtained by averaging images of two parts of the teaching video, with each part also being 1 second in duration, wherein the two parts are a part of the teaching video that is immediately before the deleted portion of the teaching video and a part of the teaching video that is immediately after the deleted portion of the teaching video. However, other existing video stitching technologies may also be utilized.

Turning back to FIG. 2, Sub-step 160 is to trim the teaching video to delete inadequate portions. Specifically, Sub-step 160 is to determine whether any portion of the teaching video (hereinafter referred to as video portion) contains a bad behavior and/or a bad facial expression of the teacher, and to delete such video portion(s), if any, from the teaching video. Recognition of bad behavior and/or facial expression may be achieved by utilizing existing recognition technologies, such as, for example, Open Source Computer Vision Library (OpenCV) and Facial Action Coding System (FACS) to determine, for each frame of the teaching video, whether the frame includes a baa behavior and/or facial expression. Examples of the bad behavior to be recognized may include being off-camera, leaving a focusing region of the camera, yawning, inappropriate sitting posture, etc. Examples of the bad facial expression to be recognized may include facial expressions showing anger, sadness, disgust, contempt, boredom, prolonged closing of eyes, etc.

According to some embodiments, Sub-step 160 may further determine, when a video portion that contains a bad behavior and/or a bad facial expression is deleted, whether a duration of the video portion exceeds a predetermined time length, and smooth the teaching video (with the video portion deleted therefrom) when the determination result is affirmative. In an embodiment, the predetermined time length is 3 seconds, but the disclosure is not limited thereto. In an embodiment, smoothing the teaching video is accomplished by obtaining a substitutional clip that has a duration of, for example, 1 second, and inserting the substitutional clip into the teaching video to replace the portion of the teaching video thus deleted. For example, the substitutional clip may be obtained. by averaging images of two parts of the teaching-video, with each part being 1 second in duration, wherein the two parts are a part of the teaching video that is immediately before the deleted video portion and a part, of the teaching video that is immediately after the deleted video portion. However, other existing video stitching technologies may also be utilized.

According to some embodiments, additional video portions may be deleted in Sub-step 160. For example, video portions involving redundant words due to stammer or stutter or incomplete words or phrases (may be detected by analyzing the text data), or video portions including a blank screen or a blurred image (may be detected by image analysis) may also be deleted, it should be noted that it is not necessary for Sub-step 160 to follow Sub-step 150. That is, Sub-step 160 may also be performed before Sub-step 150.

FIG. 4 exemplarily illustrates sub-steps of Step 200 of FIG. 1 according to an embodiment of the disclosure. Referring to FIG. 4, Step 200 may include Sub-steps 210-230.

Sub-step 210 is be compare the set of preferred characteristic tags included in the set of student tags of the user with the set of teacher characteristic tags included in the set of teacher tags of each teacher, and to select at least one candidate teacher from among the plural teachers based on the comparisons of the set of preferred characteristic tags with the sets of teacher characteristic tags. According to some embodiments, for each of the at least one candidate teacher thus selected, there is at least one teacher characteristic tag in the set of teacher characteristic tags of the candidate teacher that matches one preferred characteristic tag in the set of preferred characteristic tags. In an embodiment, for each of the at least one candidate teacher thus selected, every single one of the preferred characteristic tags included in the set of preferred characteristic tags can be found to have a match in the set of teacher characteristic tags of. the candidate teacher.

Sub-step 220 is to compare the set of interested subject tags included in the set of student tags of the user with the set of teacher subject tags included in the set of teacher tags of each of the at least one candidate teacher, and to generate a teacher match score fox: each of the at least one candidate teacher based on the comparison of the set of interested subject tags with the set of teacher subject tags corresponding to the candidate teacher. According to some embodiments, for each of the at least one candidate teacher, the teacher match score may be generated by obtaining at least one first vector from, the set of student tags, obtaining at least one second vector from the set of teacher tags of the candidate teacher, and calculating at least one cosine similarity based on the first and second vectors. In some embodiments, the least one first vector and the least one second vector are obtained by word embedding, the number of the at least one first vector thus obtained is equal to the number of interested subject tags included in the set of interested subject tags of the set of student tags, and the number of the at least one second vector thus obtained for a teacher is equal to the number of teacher subject tags included in the set of teacher subject tags of the set of teacher tags of the teacher. For example, in a case where the set of student tags includes two interested subject tags, and where the set of teacher tags of one teacher includes three teacher, subject tags, two first vectors may be obtained respectively from the two interested subject tags by converting the word(s) of each of the two interested subject tags into a corresponding word vector, and three second vectors may be obtained respectively from the three teacher subject tags by converting the word(s) of each of the three teacher subject tags into a corresponding word vector. Then, continuing with said case, six cosine similarities each between a corresponding one of the two first vectors and a corresponding one of the three second vectors are calculated, and the teacher match score of said teacher is calculated as an average of the six cosine similarities.

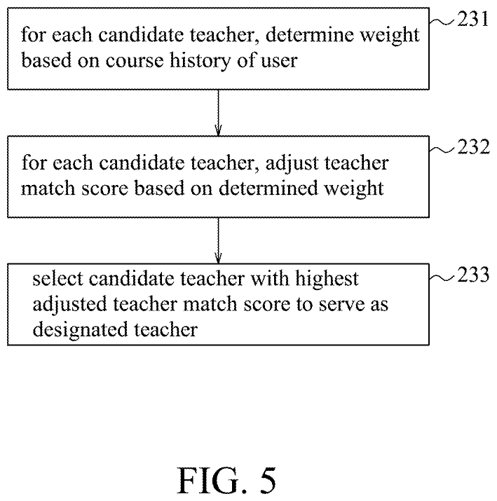

Sub-step 230 is to select the designated teacher from among the at least one candidate teacher based on the teacher match score for each of the at least one candidate teacher. Referring to FIG. 5, Sub-step 230 includes Sub-steps 231-233.

Sub-step 231 is to, for each of the at least one candidate teacher, determine a weight based on whether the user has attended at least one course taught by the candidate teacher, and further based on, when the user has attended at least one course taught by the candidate teacher, at least one grading score the user gave with respect to the at least one course of the candidate teacher. According to some embodiments, when the user has attended at least one course taught by the candidate teacher, the weight may be determined by calculating an average of the at least one grading score the user gave with respect to the course(s) and normalizing the average to a normalized value within a zero-to-one range to serve as the weight; on the other hand, when the user has never attended any course taught by the candidate teacher, the weight may be determined to have a default value. In an embodiment, the default value is one, but the disclosure is not limited thereto.

Sub-step 232 is to, for each of the at least one candidate teacher, adjust the teacher match score of the candidate teacher by multiplying the teacher match score with the weight thus determined for the candidate teacher.

Sub-step 233 is to select, from among the at least one candidate teacher, one candidate teacher with a highest adjusted teacher match score to serve as the designated teacher.

For example, in a case where five candidate teachers (namely Teacher_1 through Teacher_5) are selected in Sub-step 210 for a user having a set of interest subject tags including two interest subject tags of SB1 and SB2 (which may be, for example, “TOFEL” and “business English”), and where the five candidate teachers have their teacher subject tags as shown below,

| teacher | teacher subject tags |
|---|---|
| Teacher_1 | SB1, SB3, SB4, SB5 |
| Teacher_2 | SB2, SB4, SB6 |
| Teacher_3 | SB1, SB2 |
| Teacher_4 | SB5, SB6 |
| Teacher_5 | SB1, SB2, SB3, SB6 |

the five candidate teachers, Teacher_1 through Teacher_5, get teacher match scores of 0.354, 0.408, 1, 0 and 0.707 respectively in Sub-step 220.

Suppose that the user has attended some courses, in which three courses were taught by Teacher_1 and have got grading scores of 8 (out of 10), 9 and 8 from the user, two courses were taught by Teacher_2 and have got grading scores of 9 and 2, three courses were taught by Teacher_5 and have got grading scores of 6, 8 and 9, end none were taught by Teacher_3 or Teacher_4, in Sub-step 231, a weight tor Teacher_1 may be calculated as ((8+9+8)/3)/10=0.833, a weight for Teacher_2 may be calculated as ((9+2)/2)/10=0.55, a weight for Teacher_5 may be calculated as ((6+8+9)/3)/10=0.76, and the weights for Teacher_3 and Teacher_4 may each be determined to have the default value (e.g., 1). Then, in Sub-step 232, the teacher match scores of Teacher_1 through Teacher_5 may be adjusted as below:

Teacher_1: 0.354×0.833=0.295

Teacher_2: 0.408×0.55=0.2244

Teacher_3: 1×1=1

Teacher_4: 0×1=0

Teacher_5: 0.707×0.76=0.537

Therefore, in this example, Teacher_3 whose adjusted teacher match score is the highest would be selected to serve as the designated teacher in Sub-step 233.

Referring to FIG. 6 which illustrates a first implementation of Step 300 of FIG. 1 according to an embodiment of the disclosure, Step 300 may include Sub-steps 310-330. Sub-step 310 is to identify at least one unlearned teaching material from among the plural teaching materials. It should be understood that each of the at least one unlearned teaching material is one of the plural teaching materials, the teaching video corresponding to which has never been provided to the user. That is, the user has not attended any course related to any of the at least one unlearned teaching material.

Sub-step 320 is to compare the set of interested subject tags of the user with the set of teaching subject tags of each of the at least one unlearned teaching material, and to generate a material match score for each of the at least one unlearned teaching material based on the comparison of the set of interested subject tags with the corresponding set of teaching subject tags. According to some embodiments, for each of the at least one unlearned teaching material, the material match score may be generated by obtaining at least one third vector from the set of student tags (i.e., the at least one first vector), obtaining at least one fourth vector from the set of teaching tags of the unlearned teaching material, and calculating at least one cosine similarity based on the third and fourth vectors. In some embodiments, the least one third vector and the least one fourth vector are obtained by word embedding, the number of the at least one third vector thus obtained is equal to the number of interested subject tags included in the set of interested subject tags of the set of student tags, and the number of the at least one fourth vector thus obtained for a teaching material is equal to the number of teaching subject tags included in the set of teaching subject tags of the set of teaching material tags of the teaching material. For example, in a case where the set of student tags includes two interested subject tags, and where the set of teaching material tags of an unlearned teaching material includes three teaching subject tags, two third vectors may be obtained respectively from the two interested subject tags by converting the word(s) of each of the two interested subject tags into a corresponding word vector, and three fourth vectors may be obtained respectively from the. three teaching subject tags by converting the word(s) of each of the three teaching subject tags into a corresponding word vector. Then, continuing with, said case, six cosine similarities each between a cor ire spending one of the two third vectors and a corresponding one of the three fourth vectors are calculated, and the material match score of said teaching material is calculated as an average of the six cosine similarities.

Sub-step 330 is to select the designated teaching material from among the at least one unlearned teaching material based on the material match score for each of the at least one unlearned teaching material. In an embodiment, the one of the at least one unlearned teaching material with the highest material match score is selected to serve as the designated teaching material.

Referring to FIG. 7 which illustrates a second implementation of Step 300 of FIG. 1 according to an embodiment of the disclosure, Step 300 may include Sub-steps 340-390. Sub-step 340 is to determine, for each interested subject tag in the set of interested subject tags of the user, whether at least one teaching video that corresponds to any of the plural teaching materials with a teaching subject tag matching the interested subject tag has been provided to the user. According to some embodiments, whether the at least one teaching video has been provided to the user may be determined based on a file or history log that records which teaching video(s) has/have been provided to the user.

Sub-step 350 is to, for each interested subject tag in the set of interested subject tags of the user, calculate a tag score when it is determined in Sub-step 340 that at least one teaching video that corresponds to any or the plural teaching materials with a teaching subject tag matching the interested subject tag has been provided to the user. Specifically, the tag score is calculated as an average of at least one teaching score the user gave respectively to the at least one teaching video for the associated teaching material(s).

Sub-step 360 is to determine a set of filtered subject tags that includes every interested subject tag with a tag score not less than a first threshold. According to some embodiments, when the teaching score range the user can give is from zero to ten, the first threshold may be in a range of from one to five, four, the disclosure is not limited thereto.

The following Sub-steps 370-330 correspond to Sub-steps 310-330 of FIG. 6, respectively. Sub-step 370 is identical to Sub-step 310 in FIG. 6, and is to identify at least one unlearned teaching material from among the plural teaching materials, wherein no teaching video corresponding to any of the at least one unlearned teaching material has been provided to the user. In an advanced embodiment, Sub-step 370 is to first attempt to identify at least one unlearned teaching material, each of which has a teaching material subject tag corresponding to an interested subject tag of the user with a tag score greater than a second threshold (referred to as “senior subject tag” hereinafter), wherein the second threshold is greater than the first threshold. Then, only when no such unlearned teaching material can be identified is Sub-step 370 to further identify other unlearned teaching materials from among the plural teaching materials (i.e., the teaching material (s) that does/do not have corresponding teaching video(s) provided to the user and that does/do not have a teaching material subject tag corresponding to a senior subject tag). According to some embodiments, when the teaching score range the user can give is from zero to ten, the second threshold may be equal to or greater than seven, but the disclosure is not limited thereto.

Sub-step 330 is similar to Sub-step 320 in FIG. 6, but the comparison to be made between the set of interested subject, tags of the user with the set of teaching subject tags of each of the at least one unlearned teaching material in Sub-step 320 is replaced by comparison between the set of filtered subject tags of the user with the set of teaching subject tags of each of the at least one unlearned teaching material. Sub-step 390 is identical to Sub-step 330 in FIG. 6. Details of Sub-steps 380 and 390 that are the same as those of Sub-steps 320 and 330 will not foe repeated herein.

For example, in a case where a user has a set of interest subject tags that includes five interest subject tags of SB1 through SB2, and has watched four teaching videos (i.e., has attended four courses) that correspond respectively to four teaching materials, namely Material_1 through Material_4, and the four teaching materials have been scored by the user and have the teaching subject tag(s) shown below:

| teaching | teaching | |
|---|---|---|
| material | subject tag | score |
| Material_1 | SB1, SB2, SB3 | 2 |
| Material_2 | SB3, SB4, SB5 | 10 |
| Material_3 | SB1, SB2, SB4 | 3 |
| Material_4 | SB2, SB3, SB5 | 7 |

in Sub-step 350, interest subject tag SB1 gets a tag score of (2+3)/2=2.5, interest subject tag SB2 gets a tag score of (2+3+7)/3=4, interest subject tag SB3 gets a tag score of (2+10+7)/3=6.3, interest subject tag SB4 gets a tag score of (10+3)/2=6.5, and interest subject tag SB5 gets a tag score of (10+7)/2=8.5. Therefore, when the first threshold is set to 3, the set of filtered subject tags determined in Sub-step 360 would include only interest subject tags SB2 through SB5, and not interest subject, tag SB1. When the second threshold is set to 7, the interest subject tag SBS becomes a senior subject tag that may be used in Sub-step 370.

The disclosed method for digital learning is beneficial in that, the teaching videos provided in Step 100 are guaranteed to be free of inadequate or redundant content, and the teaching video provided to the user in Step 500 is carefully selected by Steps 200-400, so the user attending the course provided by the teaching video provided to the user may have improved learning efficiency and user experience.

In an embodiment, Steps 100-500 of the disclosed method are all performed by one computer system. However, in another embodiment, Steps 100 and 400 are performed by a first computing system, and Steps 200, 300 and 300 are performed by a second computing system that communicates with the first computing system and the electronic device possessed by the user.

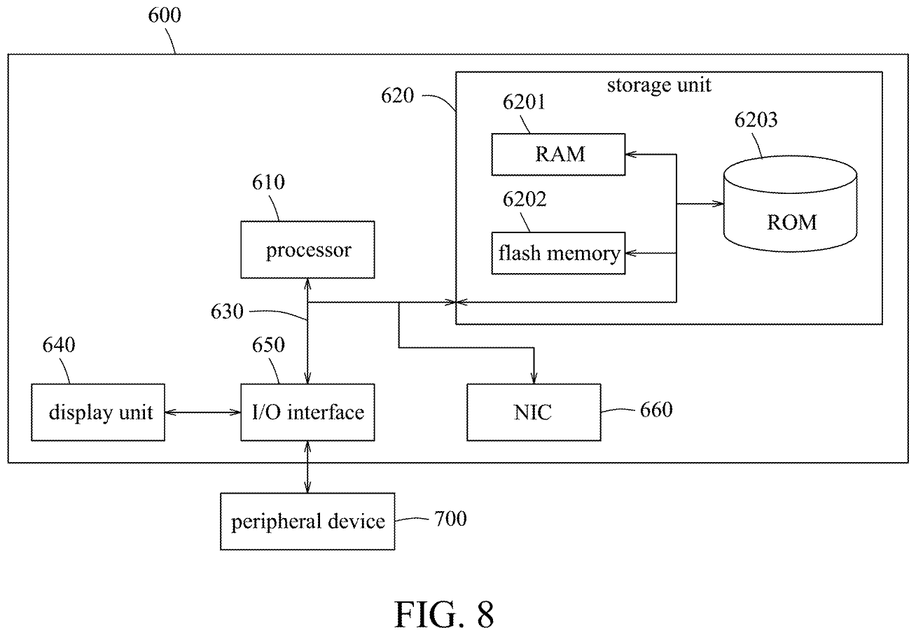

FIG. 8 exemplarily illustrates a computer system 600 that may be utilized to perform the disclosed method for digital learning according to an embodiment of the disclosure. However, the disclosure is not limited to such.

Referring to FIG. 8, the computer system 600 may be a general computer, and may include but is not limited to a processor 610, a storage unit 620, a display unit 640, and at least one bus 6.30 connecting the processor 610, the storage unit 620 and the display unit 640. The storage unit 620 stores instructions that may be executed by the processor 610 to perform the disclosed method for digital learning. In addition, the storage unit 620 may further store data and instructions of an operating system, of one or more applications, for networking, etc. According to some embodiments, the storage unit 620 may include at least one volatile memory (e.g., a random access memory (RAM) 6201 and/or flash memory 6202), and may further include read-only memory (ROM) 6203. According to some embodiments, the at least one bus 630 may each be a memory unit bus, a memory unit controller, a peripheral bus, an accelerated graphic port or a local bus.

The computer system 60C may further include an input/output (I/O) interface 650 connected by the at least one bus 630 to communicate with at least one peripheral device 700, such as a keyboard, a pointing device and/or a Bluetooth device. Further, the computer system 600 may include a network interface card (NIC) 660 connected to the at least one bus 630 and to connect with one or more networks (e.g., local area network (LAN), wide area network (WAN), or the Internet). The computer system 600 may communicate with another electronic device (e.g., an electronic device of the user) or computer system via the one or more networks.

The disclosed method for digital learning may be embodied by a non-transitory machine-readable data storage medium including program instructions for configuring a computer to perform said method. According to some embodiments, the non-transitory machine-readable data storage medium may include, but is not limited to, a compact disc read-only memory (CD-ROM), a universal serial bus (USB) flash drive, a hard disk drive (HDD), RAM, ROM, erasable programmable read-only memory (EPROM), flash memory, optical memory, magnetic memory, optical fiber, or electrical connections with one or more leads.

In the description above, for the purposes of explanation, numerous specific details have been set forth in order to provide a thorough understanding of the embodiment(s). It will be apparent, however, to one skilled In the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features ate sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for digital learning, comprising the following steps of:
providing plural teaching videos, each of which corresponds to one of plural teachers and to one of plural teaching materials;
selecting a designated teacher from among the plural teachers based on a set of student tags and plural sets of teacher tags, the set of student tags being related to a user, each of the plural sets of teacher tags being related to a respective one of the plural teachers;
selecting a designated teaching material from among the plural teaching materials based on the set of student: tags of the user and plural sets of teaching material tags, each of the plural sets of teaching material tags being related to a respective one of the plural teaching materials;
selecting, from among the plural teaching videos, a designated video that corresponds to both of the designated teacher and the designated teaching material; and
providing the designated video to the user.

2. The method of claim 1, wherein the step of providing plural teaching videos includes the following sub-step of:
for each of the plural teaching videos, obtaining the teaching video and a piece of course data related to the teaching video, the piece of course data including teacher information of the teacher that corresponds to the teaching video, and teaching material information of one of the plural teaching materials that corresponds to the teaching video.

3. The method of claim 2, wherein the step of providing plural teaching videos further Includes, for each of the plural teaching videos, the following sub-steps of:
obtaining plural pieces of text data corresponding respectively to plural speech segments in the teaching video, and plural pieces of text time information corresponding respectively to the plural pieces of text data, each of the plural pieces of text time information indicating a start time point and a finish time point of the corresponding one of the plural pieces of text data, the start time point and the finish time point corresponding respectively to a start time point and a finish time point of one of the plural speech segments that corresponds to the corresponding one of. the plural pieces of text data;
obtaining, based on the teaching material information in the piece of course data related to the teaching video, plural pieces of page time information that correspond respectively to plural video segments of the teaching video, the plural video segments corresponding respectively to plural pages of said one of the plural teaching materials that corresponds to the teaching video, wherein each of the plural pieces of page time information indicates a start time point and a finish time point of the corresponding one of the video segments; and
for each of the plural pieces of text data, relating the piece of text data to one of the plural pages of said one of the plural teaching materials based on the corresponding one of the plural pieces of text time information and the plural pieces of page time information.

4. The method of claim 3, wherein the step of providing plural teaching videos further includes, for each of the plural teaching videos, the following sub-steps of:
storing the plural pieces of text data in chronological order based on the plural pieces of text time information;
for each of the plural pieces of text data, determining whether the piece of text data is related to one of the plural pages that is related to another one of the plural pieces of text data that is immediately before the piece of text data in the chronological order;
when it is determined that the piece of text data is related to said one of the plural, pages that is related to said another one of. the plural pieces of text delta,
determining whether a time interval between the finish time point, of. said another one of the plural pieces of text data and the start time point of the piece of text data exceeds a first time length, and
when it is determined that the time interval exceeds the first time length, deleting a portion of the teaching video between one of the plural speech segments that corresponds to the piece of text, data and one of the plural speech segments that corresponds to said another one of the plural pieces of text data; and
when it is determined that the piece of text data is not related to said one of the plural pages that is related to said another one of the plural pieces of text data,
determining whether the time interval exceeds a second time length that is greater than the first time length, and
when it is determined that the time interval exceeds the second time length, deleting the portion of the teaching video.

5. The method of claim 3, wherein the step of providing plural teaching videos further includes the following sub-step of:
after the portion of the teaching video is deleted, smoothing the teaching video.

6. The method of claim 5, wherein smoothing the teaching video includes the following sub-steps of:
obtaining a substitutional clip by averaging images of a first part of the teaching video and images of a second part of the teaching video, wherein the first part of the teaching video is immediately before the portion of the teaching video, and the second part of the teaching video is immediately after the portion of the teaching video; and
inserting the substitutional clip into the teaching video to replace the portion of the teaching video thus deleted.

7. The method of claim 3, wherein the step of providing plural teaching videos further includes, for each of the plural teaching videos, the following sub-steps of:
determining whether any video portion of the teaching video contains at least one of a bad behavior or a bad facial expression of the teacher; and
when it is determined that a video portion of the teaching video contains at least one of a bad behavior or a bad facial expression of the teacher, deleting the video portion from the teaching video*

8. The method of claim 7, wherein the step of providing plural teaching videos further includes the following sub-steps of:
determining whether a duration of the video portion exceeds a predetermined time length; and
when it is determined that the duration of the video portion exceeds the predetermined time length, smoothing the teaching video.

9. The method of claim 8, wherein smoothing the teaching video includes the following sub-steps of:
obtaining a substitutional clip by averaging images of a first part of the teaching video and images of a second part of the teaching video, wherein the first part of the teaching video is immediately before the video portion, and the second part of the teaching video is immediately after the video portion; and
inserting the substitutional clip into the teaching video to replace the video portion.

10. The method of claim 1, the set of student tags of the user including a set of preferred characteristic tags and a set of interested subject tags, each of the plural sets of teacher tags including a set of teacher characteristic tags and a set of teacher subject tags, wherein the step of selecting a designated teacher includes the following sub-steps of:
comparing the set of preferred characteristic tags of the user with the set of teacher characteristic tags of each of the plural sets of teacher tags that correspond to the plural teachers, so as to select at least one candidate teacher from among the plural teachers;
comparing the set of interested subject tags of the. user with the set of teacher subject tags of each of at least one of the plural sets of teacher tags that corresponds respectively to the at least one candidate teacher, so as to generate a teacher match score for each of the at least one candidate teacher; and
selecting the designated teacher from among the at least one candidate teacher based on the teacher match score fox each of the at least one candidate teacher.

11. The method of claim 10, wherein:
the step of selecting a designated teacher further includes, for each of the at least one candidate teacher, the following sub-steps of:
determining a weight based on whether the user has attended at least one course taught by the candidate teacher and further based on, when the user has attended at least one course taught by the candidate teacher, at least one grading score the user gave with respect to the at least one course taught by the candidate teacher; and
adjusting the teacher match score of the candidate teacher by multiplying the teacher match score with the weight thus determined with respect to the candidate teacher; and
the sub-step of selecting a designated teacher is to select one of the at least one candidate teacher with a highest teacher match score thus adjusted to serve as the designated teacher.

12. The method of claim 1, each of the plural sets of teaching material tags including a set of teaching subject tags, wherein the step of selecting a designated teaching material includes the following sub-steps of:
identifying at least one vs n learned teaching material from among the plural teaching materials, no teaching video corresponding to any of the at least one unlearned teaching material having been provided to the user;
comparing the set of interested subject tags of the user with the set of teaching subject tags of each of the at least one unlearned teaching material, so as to generate a material match score for each of the at least one unlearned teaching material; and
selecting the designated teaching material from among the at least one unlearned teaching material based on the material match score for each of the at least one unlearned teaching material*

13. The method of claim 1, each of the plural sets of teaching material tags including a set of teaching subject tags, wherein the step of selecting a designated teaching material includes the following sub-steps of:
for each interested subject tag in the set of interested subject tags of the user,
determining whether at least one teaching video that corresponds to any of the plural teaching materials with a teaching subject tag matching the interested subject tag has been provided to the user, and
when it is determined that at least one teaching video that, corresponds to any of the plural teaching materials with a teaching subject tag matching the interested subject tag has been provided to the user, calculating a tag score of the interested subject tag as an average of at least one teaching score the user gave respectively to the at least one teaching video; and
determining a set of filtered subject tags that includes every interested subject tag with a tag score not less than a first threshold.

14. The method of claim 13, wherein the step of selecting a designated teaching material further includes the following sub-steps of:
identifying at least one unlearned teaching material from among the plural teaching materials, no teaching video corresponding to any of the at least one unlearned teaching material having been provided to the user;
comparing the set of filtered subject tags with the set of teaching material subject fags of each of the at least one unlearned teaching material to generate a material match score for each of the at least one unlearned teaching material; and
selecting the designated teaching material from among the at least one unlearned teaching material based on the material match score for each of the at least one unlearned teaching material.

15. The method of claim 14, wherein the sub-step of identifying at least one unlearned teaching material is to identify at least one unlearned teaching material, each of which has a teaching material subject tag that corresponds to an interested subject tag of the user with a tag score greater than a second threshold, the second threshold being greater than the first threshold.

16. The method of claim 1, wherein:
the step of selecting a designated teacher includes the following sub-steps of:
obtaining at least one first vector from the set of student tags,
for each of the plural teachers, obtaining at least one second vector from the set of teacher tags of the teacher,
for each of the plural teachers, calculating at least one first cosine similarity based on the at least one second vector that corresponds to the teacher and on the at least one first vector,
for each of the plural teachers, calculating a teacher match score based on the at least one first cosine similarity calculated for the teacher, and
selecting one of the plural teachers that corresponds to a highest one of the teacher match scores respectively of the plural teachers thus calculated to serve as the designated teacher; and
the step of selecting a designated teaching material includes the following sub-steps of:
obtaining at least one third vector from the set of student tags,
for each of the plural teaching materials, obtaining at least one fourth vector from the set of teaching material tags of the teaching material,
for each of the plural teaching materials, calculating at least one second cosine similarity based on the at least one fourth vector that corresponds to the teaching material and on the at least one third vector,
for each of the plural teaching materials, calculating a material match score based on the at least one second cosine similarity calculated for the teaching material, and
selecting one of the plural teaching materials that corresponds to a highest one of the material match scores respectively of the plural teaching materials thus calculated to serve as the designated teaching material.

17. A non-transitory machine-readable data storage medium comprising program instructions for configuring a computer to perform a method for digital learning according to claim 1.
